(19) United States
(12) Patent Application Publication
(10) Pub. No.: US 2024/0003508 A1
(43) Pub. Date: Jan. 4, 2024

(54) Rear Mounted Light Display

(71) Applicant: Kathy Kennedy Finlaw, Akron, OH (US)

(72) Inventor: Kathy Kennedy Finlaw, Akron, OH (US)

(21) Appl. No.: 18/345,057

(22) Filed: Jun. 30, 2023

Related U.S. Application Data
(60) Provisional application No. 63/357,057, filed on Jun. 30, 2022.

(51) Int. Cl. F21S 9/02; F21V 21/096; F21S 4/24; F21V 21/40; F21V 21/04

(52) U.S. Cl. CPC F21S 9/02; F21V 21/096; F21S 4/24; F21V 21/40; F21V 21/047; F21W 2104/00

(57) ABSTRACT

An externally mounted vehicle light display is provided. The light display includes a light display body having an external surface and an internal surface. A plurality of magnets are secured to the internal surface of the light display body while a plurality of light string securement means are also secured to the internal surface of the light display body. A removal facilitating knob is secured to the external surface of the light display body. A battery powered light string is carried on the plurality of light string securement means. Another embodiment provides lights adhered in a track running around the exterior of the light display. Another embodiment has a circular frame containing a track for the lights to be adhered in a central position.

### FIELD OF THE INVENTION

The present invention generally relates to light displays to be mounted on a vehicle. The present invention specifically relates to light displays to be mounted on an exterior surface of a vehicle. The present invention more specifically relates to a light display that is mounted on an exterior surface of a spare tire and wherein the light display is not powered by the vehicle's battery.

### BACKGROUND OF THE INVENTION

Vehicles are an essential part of everyday life. Consumers have been looking for ways to individualize/personalize vehicles once they purchase them from the dealers, as most cars look substantially the same. In an effort to do so, consumers have utilized things such as bumper stickers or unique paint jobs to individualize/personalize their vehicles.

Consumers have also utilized light displays in an effort to individualize/personalize their vehicles. The most common form of a light display would typically be thought of as a neon strobe light that is secured around the bottom perimeter of the vehicle. These light displays are typically powered either by being directly connected to the vehicle battery, or they are sometimes plugged into a cigarette lighter or charging port on the interior of the car and connected to the car's battery in that manner.

However, connecting a light display directly to the car's battery has some downside, particularly because connecting the light display to the car's battery will drain the battery faster, sometimes completely draining the battery of its power, leading to the need to “jump” the battery. Therefore, there is a need in the art for a light display that can be mounted on an exterior surface of a spare tire and wherein the light display is not powered by the vehicle's battery.

### SUMMARY OF THE INVENTION

An embodiment of the present invention provides an externally mounted vehicle light display, the light display comprising: a light display body having an external surface and an internal surface; a plurality of magnets secured to the internal surface of the light display body; a plurality of light string securement means secured to the internal surface of the light display body; a battery powered light string carried on said plurality of light string securement means; and a removal facilitating knob secured to the external surface of the light display body.

Another embodiment of the present invention provides A vehicle light display mounted over the wheel of a spare tire, the wheel being attached to the rear of the vehicle, the light display comprising: a light display body having an external surface and an internal surface; a string or a strip of lights disposed on the internal surface of the display; a battery power source operatively connected to the string or strip of lights; and a removal facilitating locking bracket secured by a mounting bracket to the wheel of the spare tire, wherein at least a portion of the bracket passes through a central hole to the external surface of the light display body.

In an embodiment, the frame assembly wraps around the exterior of the light display and has a track on the internal surface of the light display where the string or strip of lights is operatively connected.

In accordance with a second aspect of the invention, there is a circular frame with a hole in the center that is operatively connected to the internal surface with a track on its circumference where the string or strip of lights is operatively connected.

In accordance with a third aspect of the invention, there is a locking bracket comprising: a y-shaped mounting bracket that is secured to the lug holes of the tire; an extension piece; a spacer bracket connected to the interior locking mechanism, where the long side of the spacer bracket is screwed to the y-shaped mounting bracket and the interior locking mechanism passes through the light display; a locking handle that fits over the interior locking mechanism.

### BRIEF DESCRIPTION OF THE DRAWINGS

These and other features and advantages of the present invention will become better understood with regard to the following description, appended claims, and accompanying drawings wherein:

FIG. 1 shows a front view of a first embodiment of a light display of the present invention;

FIG. 2 shows the rear view of the light display of FIG. 1;

FIG. 3 shows the rear view of a vehicle prior to the light display of FIG. 1 being secured to a spare tire of the vehicle;

FIG. 4 shows the light display of FIG. 1 mounted to the spare tire as shown in FIG. 3;

FIG. 5 shows a side view of the vehicle of FIG. 3 with the light display of FIG. 1 mounted to the spare tire;

FIG. 6 shows a front view of a second embodiment of a light display of the present invention;

FIG. 7 shows the rear view of the light display of FIG. 6;

FIG. 8 shows the front view of the second embodiment of FIG. 6 with the locking bracket;

FIG. 9 shows a cross-sectional view taken along the line 9-9 in FIG. 8; and

FIG. 10 shows a front view of a third embodiment of a light display of the present invention.

### DETAILED DESCRIPTION OF ILLUSTRATIVE EMBODIMENTS

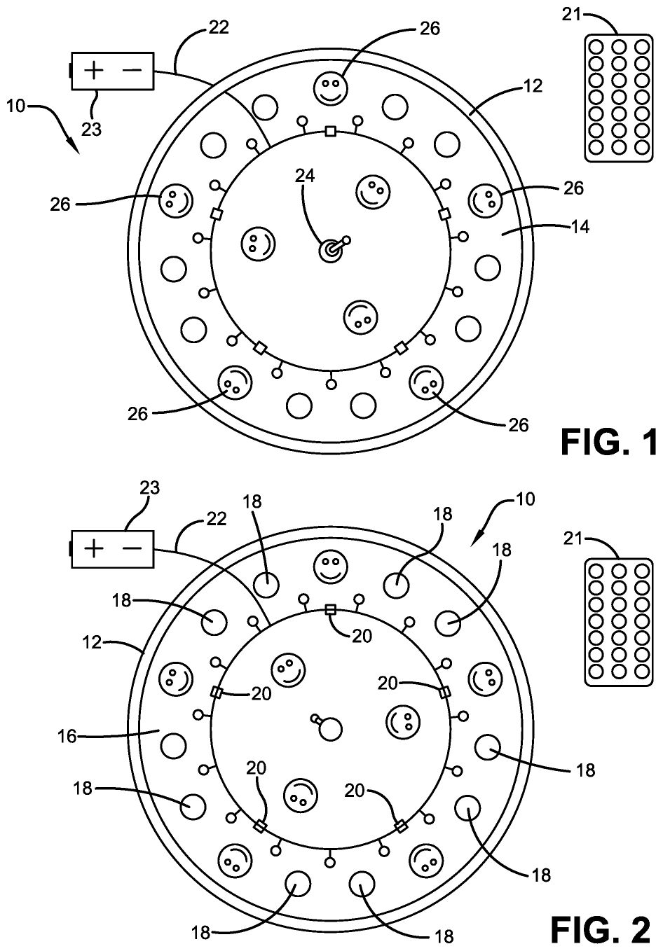

A first embodiment of the light display of the present invention is shown as light display 10 in FIGS. 1 and 2. Light display 10 includes a generally circular body 12 having an external surface 14 and an internal surface 16, a plurality of magnets 18 located on said internal surface 16, a plurality of light string hooks 20 located on said internal surface 16, a battery powered light string 22 that is operated by remote controller 21 is carried by said light string hooks 20, and a removal facilitating knob 24 is located on said external surface 14. In some embodiments, light display 10 can also include decorative indicia 26 located on said external surface 14 or on said internal surface 16. The decorative indicia 26 is shown in FIGS. 1 and 2 as being smiling faces, but any design can be used to decorate the light display 10.

In one or more embodiments, the generally circular body 12 is made from a plexiglass material that can be either opaque or clear.

In one or more embodiments, the battery powered light string 22 can be either a string of lights or an LED light strip. In one or more embodiments, what is meant by a battery powered light string 22 is a light string that is not powered by the vehicle's battery and is instead powered by its own battery pack 23, which power source is operatively connected to the lights 22. In one or more embodiments, the battery pack 23 may, as an example, contain lithium batteries to power the light display. In one or more embodiments, the light string 22 can be operated using a remote controller 21, which can be used to turn the lights 22 on and off, as well as change the color of the lights 22.

In one or more embodiments, the plurality of magnets 18 are secured to the internal surface 16 by an adhesive and the plurality of magnets 18 include from 4 to 16 magnets. In one or more embodiments, the plurality of light string hooks 20 are secured to the internal surface 16 by an adhesive and the plurality of light string hooks 20 include from 4 to 15 total light string hooks.

In one or more embodiments, the light display 10 could also include a locking mechanism located on the internal surface 16 of the circular body. The locking mechanism would lock the light display 10 to the spokes of the wheel of a spare tire T. It is contemplated that the locking mechanism would have a rotating arm component that would be locked with the spokes of the spare tire T in one position and not locked with the spokes of the spare tire in a second position. The locking mechanism would comprise additional means, along with the plurality of magnets 18 in order to secure the light display when placed on a spare tire T. In an alternative embodiment, the locking mechanism could lock the light display 10 to the rim of the wheel of the spare tire T. The locking mechanism would be offset from the center of the light display such that its elongated or extended arm could be positioned close enough to the rim or spoke to engage the rim or spoke upon actuation and locking of the mechanism. In this manner the light display could not then be removed easily from the wheel of the spare tire. In an alternative embodiment, a bracket 34 could be screwed to the rim R of the spare tire and include a locking handle 45 so the light display 10 could be changeable by the vehicle owner, but not easily removed from the wheel of the spare tire by someone other than the owner.

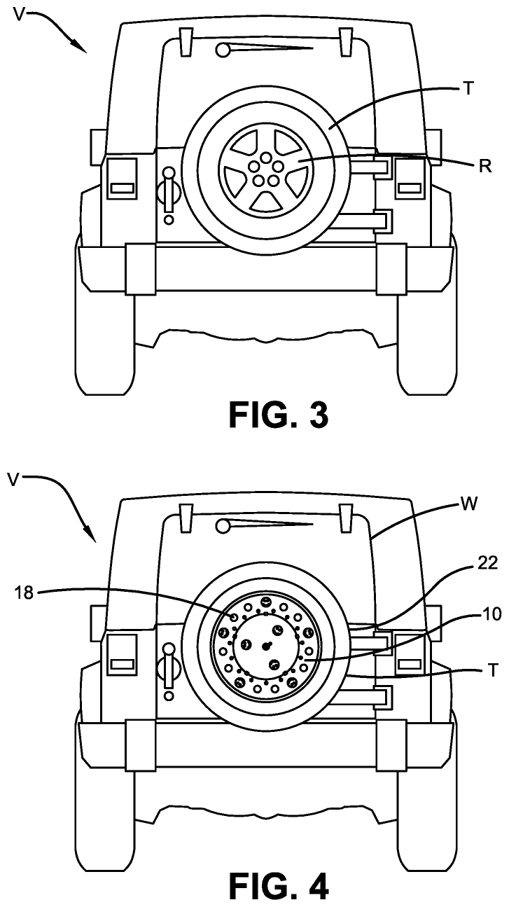

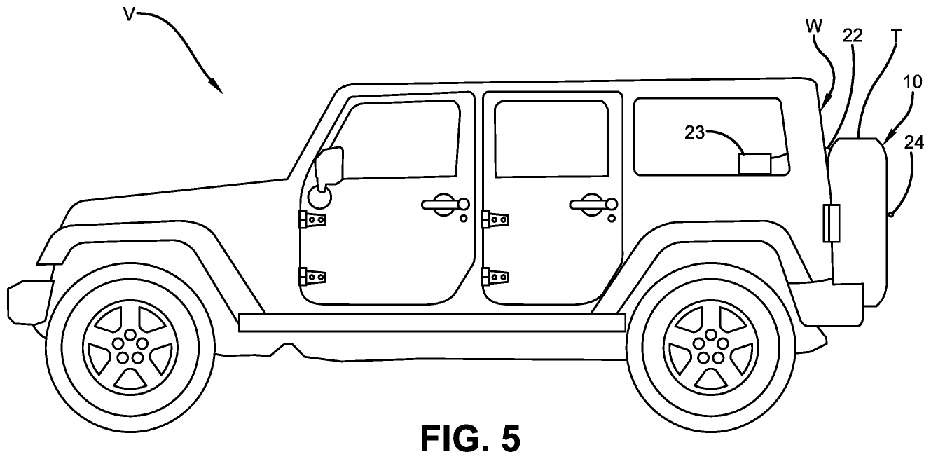

FIG. 3 shows the rear surface of a vehicle V that has a spare tire T mounted to a rear surface of the vehicle V. FIGS. 4 and 5 show the light display 10 from FIGS. 1 and 2 secured to a spare tire T that is mounted to the external rear surface of a vehicle V. Specifically, the plurality of magnets 18 of light display 10 are mounted onto the metal spokes of rim R of the spare tire T. As shown in FIG. 5, prior to ultimately mounting the light display 10 to the metal rim R, the battery pack 23 of the battery powered light string 22 should be drawn out away from the light display 10 such that it can be placed within the vehicle V so as to protect the battery pack 23 from the elements. In some embodiments, this is accomplished by opening the back window W of the vehicle V and placing the battery pack 23 within the back seat/trunk of the vehicle. As shown in FIGS. 4 and 5, the light display 10 is positioned in front of the metal spokes of the rim R and not behind the metal spokes of the rim R. Additionally, the light display 10 of the present invention is magnetically mounted to the rim R of tire T and is not mounted directly to the wheel mount to which said tire T is mounted. Finally, from the description above, it should be clear that, in this embodiment, the light display 10 can be secured to the spare tire T without the use of any external tools. To remove the light display 10, the user simply has to grab the removal facilitating knob 24 located on said external surface 14 and pull, which will force the plurality of magnets 18 to break their magnetic connection with the metal spokes of rim R and the light display 10 is considered unmounted.

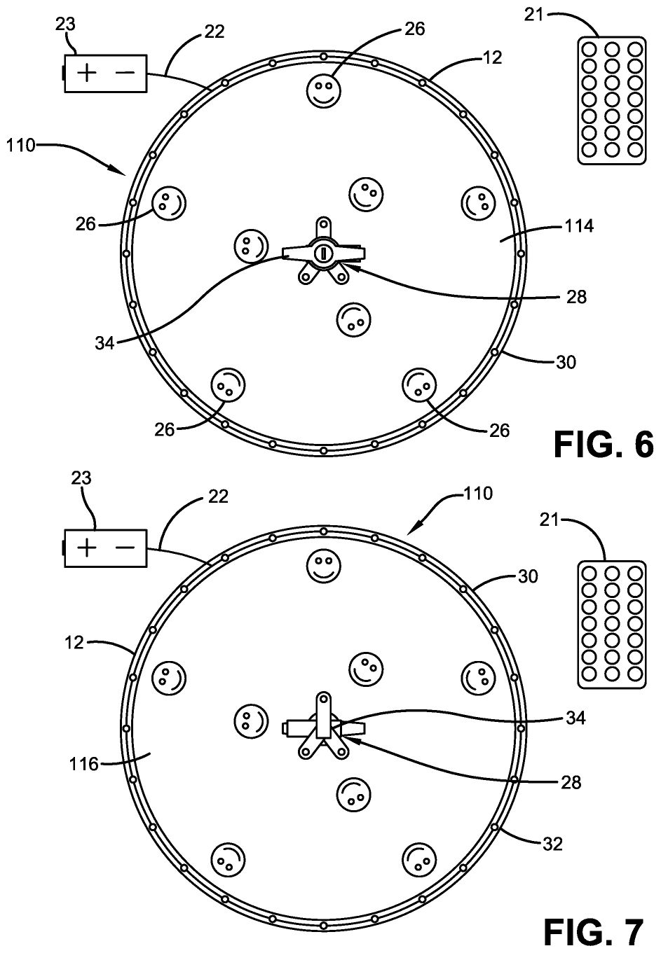

A second embodiment of the light display of the present invention is shown as light display 110 in FIGS. 6 and 7. Light display 110 includes a generally circular body 12 having an external surface 114 and an internal surface 116, a center hole 28 in the light display 110, a frame assembly 30 that extends around the exterior of the light display 110, a battery powered light string 22 controlled by remote controller 21 to be operatively attached inside the frame assembly 30, as with an adhesive, with the lights facing the center hole 28 in the circular body 12, and a locking removal bracket 34, wherein at least a portion of the bracket 34 passes through the center hole 28 from said internal surface 116 to said external surface 114. In some embodiments, light display 110 can also include decorative indicia 26 located on said external surface 114 or on said internal surface 116. The decorative indicia 26 is shown in FIGS. 6 and 7 as being smiling faces, but any design can be used to decorate the light display 110.

In one or more embodiments, the light display 110 includes a frame assembly 30 where the radially inward portion of the frame 30 includes a lights track 32 and the circular body 12. The lights 22 in the frame assembly 30 are axially inward of the circular body 12 placed in the light track 32 and are operatively connected to the track 32, as with an adhesive.

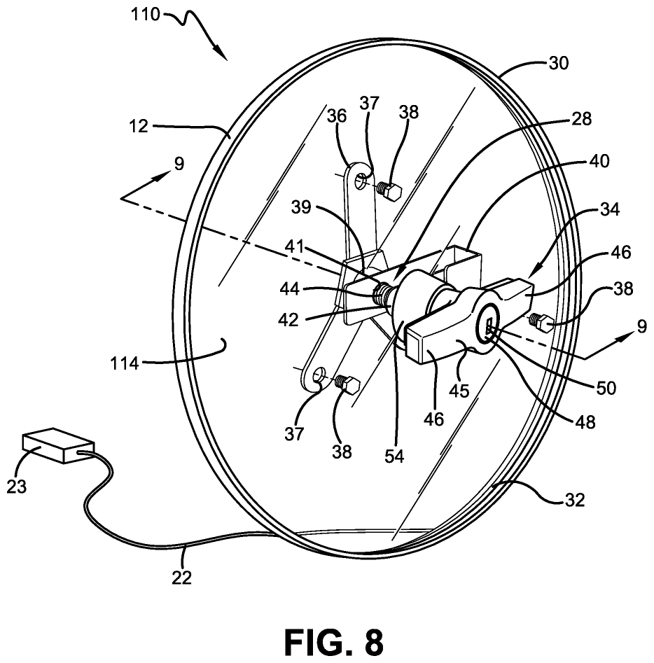

In one or more embodiments, the light display 110 could also include a locking bracket 34, shown in FIG. 8, wherein at least a portion of the bracket passes through the central hole 28 from the internal surface 116 of the circular body 12 to the external surface 114. A Y-shaped metal bracket 36 has a hole 37 at the end of each arm of the Y-bracket where a bolt 38 secures the Y-bracket 36 to the lug holes of the rim R of the spare tire T. An extension 39 sits between the Y-bracket 36 and a spacer bracket 40. The spacer bracket 40 has three sides a through bore 42 containing an interior locking flange 43. The long side of the spacer bracket 40 contains a hole 41 that lines up with the center of the Y-shaped bracket 36. A screw 44 passes through hole 41 to screw into the Y-shaped bracket 36. The second side of the spacer bracket is a shorter side extending 90 degrees perpendicular from the long side towards the internal surface 116 of the light display 110. The third side of the spacer bracket 40 extends 90 degrees perpendicular from the short side toward the center hole 28 and rests against the internal surface 116. A through bore 42 extends 90 degrees perpendicular from the third side towards the internal surface 116 and contains the interior locking flange 43 that passes through the center hole 28. The outer circumference of the through bore 42 is just smaller than the circumference of the center hole 28. In the center of the locking handle 45 is the lock mechanism 48 with a keyhole 50. Below the locking handle 45 is a hollow extension 52 and a hollow base covering 54 that makes contact with the external surface 114 of the light display 110 and covers the locking mechanism 48. The locking handle 45 has two wings 46 that extend in opposite directions from the center of the handle 45, which allows for an easier grip to assemble the locking bracket 34 to secure the light display 110. In this manner the light display 110 could not then be removed easily from the wheel of the spare tire. The light display 110 has an exterior frame assembly 30 where the radially inward portion of the frame assembly 30 includes a lights track 32 where the lights 22 are operatively connected and the circular body 12 is axially outward of the lights 22.

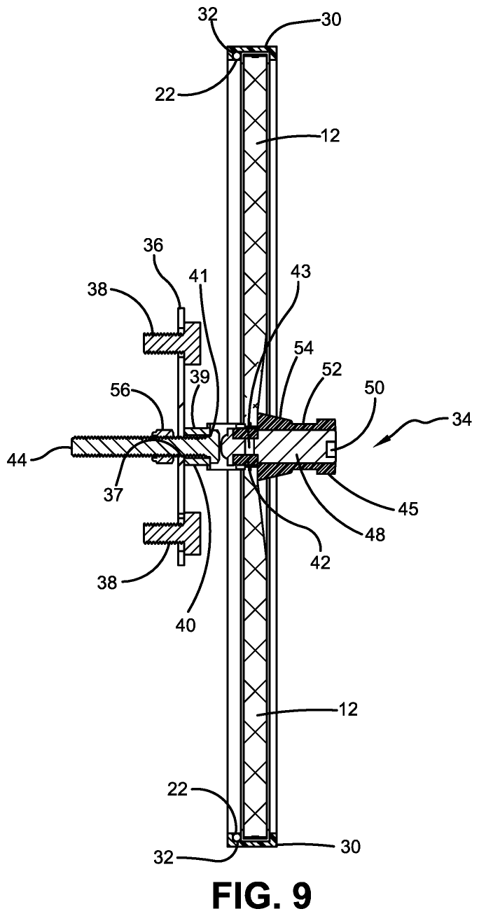

FIG. 9 shows a side view of the locking bracket 34 shown in FIG. 8. The first end of the locking bracket 34 contains the keyhole 50 and the second end of the locking flange 42. The keyhole 50 turns the locking mechanism 48 which is covered by the hollow extension 52 and the base covering 54. The locking handle 45 sits against the exterior surface 114 and the locking mechanism 48 passes through center hole 28 of the circular body 12. The locking mechanism 48 rotates to engage the interior locking flange 43 located in the through bore 42 so the light display 110 cannot be removed easily from the spare tire. Touching the interior surface 116 of the circular body 12 is the spacing bracket 40 which includes the through bore 42 and the interior locking flange 43. The spacer bracket 40 is semi-flexible to enable screw 44 to be inserted into hole 41. Screw 44 which secures the spacer bracket 40, the extension 39, and the Y-bracket 36 using hole 41, hole 37, and a nut 56. The Y-bracket 36 is secured to the rim utilizing bolts 38. The light display 110 has an exterior frame assembly 30 where the radially inward portion includes a lights track 32 where the lights 22 are operatively connected and the circular body 12 is axially outward of the lights 22.

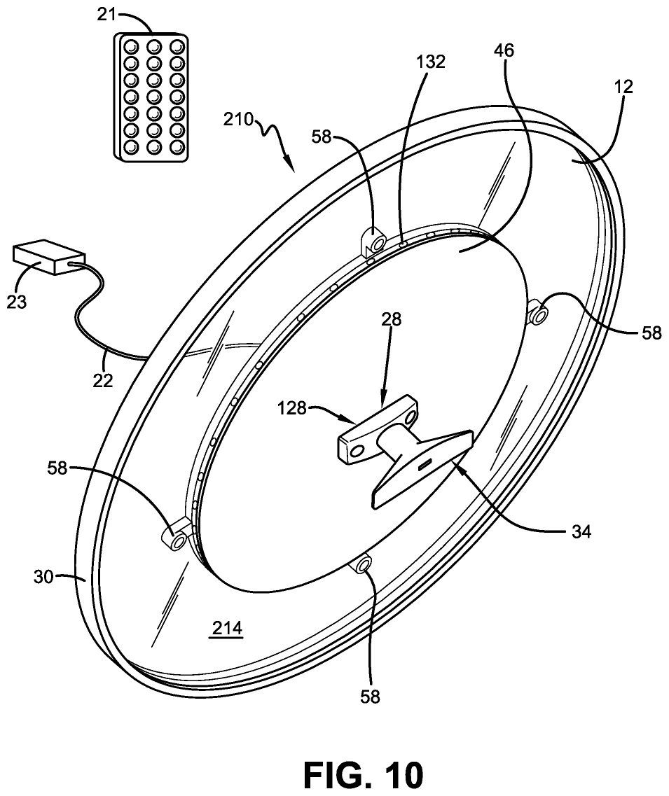

A third embodiment of the light display of the present invention is shown as light display 210 in FIG. 10. Light display 210 includes a generally circular body 12 having an external surface 214, an internal surface 216, a center hole 28, and a light holding assembly 56. The light holding assembly 56 is mounted to the internal surface 216 using nut and bolt 58 and contains a radially inward track 132 and a light holding assembly hole 128. The battery powered light strip 22 operated by remote controller 21 is operatively connected into the track 132, such as by adhesive. The light holding assembly hole 128 is similar or larger in circumference than the center hole 28. The light display 210 is secured to the vehicle using a locking removal bracket 34, wherein at least a portion of the bracket 34 passes through the center hole 28 and the light holding assembly hole 128 from said internal surface 216 to said external surface 214. The lights 22 are operatively adhered to the track 132 so that the lights 22 face the outer frame Although not shown in FIG. 10 relating to the third embodiment, light display 210 can also include decorative indicia similar to that shown in FIGS. 1 and 2 for the first embodiment where the decorative indicia 26 located on said external surface 14 or internal surface 16. The second embodiment contains a similar example of possible decorative indicia in FIGS. 6 and 7 where the decorative indicia 26 is located on said external surface 114 or said internal surface 116.

Thus, in operation, a user may secure the light display to the wheel of the spare tire by first bolting the Y-bracket 36 using the holes 37 and bolts 38 to the rim R of the vehicle V. Then a user places the extension 39 and the spacer bracket 40 next to the Y-bracket 36 and using screw 44 and nut 56 secure the pieces to each other. Screw 44 passes through the center hole 41, the extension 39, and through the center of the Y-bracket 36 to nut 56. Next a user places the light display 110 or light display 210 so that through bore 42 of the spacer bracket passes through the center hole 28. The light display 110 or light display 210 rests against the spacer bracket 40. Finally, the locking handle 45 is placed so the lock mechanism 48 passes over the through bore 42. Using the keyhole 50 the lock mechanism 48 engages the interior locking flange 43 securing the light display 110 or light display 210 to the vehicle V. Once the light display 110 or light display 210 has been placed onto the vehicle V the battery 23 is then placed into the vehicle V through the back window W and the lights 22 can then be controlled by the remote 21.

In light of the foregoing, it should be appreciated that the present invention significantly advances the art by providing a light display to be mounted on an exterior surface of a spare tire that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. An externally mounted vehicle light display, the light display comprising:
a. a light display body having an external surface and an internal surface;
b. a plurality of magnets secured to the internal surface of the light display body;
c. a plurality of light string securement means secured to the internal surface of the light display body;
d. a battery powered light string carried on said plurality of light string securement means; and
e. a removal facilitating knob secured to the external surface of the light display body.

2. A vehicle light display mounted over the wheel of a spare tire, the wheel being attached to the rear of the vehicle, the light display comprising:
a. a light display body having an external surface and an internal surface;
b. a string or a strip of lights disposed on the internal surface of the display;
c. a battery power source operatively connected to the string or strip of lights; and
d. a removal facilitating locking bracket secured by a mounting bracket to the wheel of the spare tire, wherein at least a portion of the bracket passes through a central hole to the external surface of the light display body.

3. The device of claim 2, a frame assembly that wraps around the exterior of the light display and has a track on the internal surface of the light display where the string or strip of lights is operatively connected.

4. The device of claim 2, a circular frame with a hole in the center that is operatively connected to the internal surface with a track on its circumference where the string or strip of lights is operatively connected.

5. The device of claim 2, wherein the locking bracket comprising:
a. a y-shaped mounting bracket that is secured to the lug holes of the tire;
b. an extension piece;
c. a spacer bracket connected to the interior locking mechanism, where the long side of the spacer bracket is screwed to the y-shaped mounting bracket and the interior locking mechanism passes through the light display;
d. a locking handle that fits over the interior locking mechanism.
